(19) United States
(12) Patent Application Publication
(10) Pub. No.: US 2020/0183221 A1
(43) Pub. Date: Jun. 11, 2020

(54) LIQUID CRYSTAL DISPLAY DEVICE

(71) Applicant: SHARP KABUSHIKI KAISHA, Sakai City (JP)

(72) Inventor: HAJIME SAITOH, Sakai City (JP)

(21) Appl. No.: 16/700,565

(22) Filed: Dec. 2, 2019

Related U.S. Application Data
(60) Provisional application No. 62/775,785, filed on Dec. 5, 2018.

(51) Int. Cl. G02F 1/1333; G02F 1/1335; G02F 1/1368

(52) U.S. Cl. CPC G02F 1/133345; G02F 1/133504; G02F 1/133553; G02F 2202/022; G02F 2001/133565; G02F 2001/13685; G02F 2203/02; G02F 1/1368

(57) ABSTRACT

The liquid crystal display device includes: a first substrate; a second substrate facing the first substrate; and a liquid crystal layer between the first substrate and the second substrate. The first substrate includes first electrodes for applying voltage to the liquid crystal layer, an uneven insulating layer disposed on a liquid crystal layer side of the first electrodes and including a first uneven structure on a liquid crystal layer side surface, and a reflective layer covering the first uneven structure of the uneven insulating layer and including a second uneven structure on a liquid crystal layer side surface. The reflective layer is electrically insulated from the first electrodes by the uneven insulating layer. A material of the uneven insulating layer and a liquid crystal material have a difference in relative permittivity of 0.3 or less. The second substrate includes a second electrode for applying voltage to the liquid crystal layer.

### CROSS-REFERENCE TO RELATED APPLICATIONS

The present application claims priority under 35 U.S.C. § 119 to U.S. Provisional Application No. 62/775,785 filed on Dec. 5, 2018, the contents of which are incorporated herein by reference in their entirety.

### BACKGROUND OF THE INVENTION

### Field of the Invention

The present invention relates to liquid crystal display devices.

### Description of Related Art

Liquid crystal display devices utilize a liquid crystal layer (liquid crystal molecules) for image display. Recently, liquid crystal display devices are widely used for mobile devices and are expected to have characteristics such as a thin profile, light weight, and low power consumption. Meanwhile, reflective liquid crystal display devices that do not need a back light (e.g., JP 2001-154190 A, JP 2009-237019 A) have been proposed. Reflective liquid crystal display devices provide display utilizing reflected light obtained by external light reflection. Specifically, voltage is applied to a liquid crystal layer so that the alignment of liquid crystal molecules is changed to control the amount of the reflected light passing through the liquid crystal layer.

### BRIEF SUMMARY OF THE INVENTION

Studies have been made to achieve a reflective liquid crystal display device that includes an uneven reflection surface and thus can efficiently reflect incident light (external light) from various directions to the front. Unfortunately, the uneven surface causes positional variation in thickness of the liquid crystal layer, which further causes positional variation in retardation of the liquid crystal layer. Thereby, the reflective liquid crystal display device may have a locally reduced contrast ratio.

In response to this issue, JP 2001-154190 A discloses a reflective liquid crystal display device in which a liquid crystal layer is held between transparent electrodes and thereby has a constant thickness, and a scattering reflective layer including an uneven structure is disposed farther from the liquid crystal layer than one of the transparent electrodes is. Unfortunately, in the liquid crystal display device disclosed in JP 2001-154190 A, incident light (external light) passes through a different layer (e.g., flattening layer) when traveling from the liquid crystal layer to the scattering reflective layer and light reflected by the scattering reflective layer passes through the different layer (e.g., flattening layer) again when traveling to the liquid crystal layer. Light loss is thereby increased, resulting in a reduced reflectance.

JP 2009-237019 A discloses a liquid crystal display device that includes: a reflective film whose surface includes an uneven pattern; a first resin layer whose liquid crystal layer side surface has the same uneven pattern as that of the reflective film; and a second resin layer which faces the first resin layer with the liquid crystal layer in between and whose surface has a reverse uneven pattern to the uneven pattern of the reflective film. The liquid crystal layer has a constant thickness. Unfortunately, in the technique disclosed in JP 2009-237019 A, it is difficult to make two resin layers have reverse uneven surfaces corresponding to each other. Besides, the structure in which the reflective film is disposed apart from the liquid crystal layer reduces the reflectance due to the same reason as in JP 2001-154190 A.

The present invention has been made under the current situation in the art and aims to provide a liquid crystal display device capable of improving the reflectance and the contrast ratio.

(1) An aspect of the present invention is a liquid crystal display device including: a first substrate; a second substrate facing the first substrate; and a liquid crystal layer between the first substrate and the second substrate, the first substrate including first electrodes for applying voltage to the liquid crystal layer, an uneven insulating layer disposed on a liquid crystal layer side of the first electrodes and including a first uneven structure on a liquid crystal layer side surface, and a reflective layer covering the first uneven structure of the uneven insulating layer and including a second uneven structure on a liquid crystal layer side surface, the reflective layer being electrically insulated from the first electrodes by the uneven insulating layer, a material of the uneven insulating layer and a liquid crystal material of the liquid crystal layer having a difference in relative permittivity of 0.3 or less, the second substrate including a second electrode for applying voltage to the liquid crystal layer.

(2) In an embodiment of the present invention, the liquid crystal display device includes the structure (1) and the uneven insulating layer is disposed on the liquid crystal layer side of the first electrodes and includes an uneven layer formed of projections and an insulating layer covering the projections of the uneven layer and including the first uneven structure on the liquid crystal layer side surface, the reflective layer is electrically insulated from the first electrodes by the insulating layer, and a material of the uneven layer and the liquid crystal material of the liquid crystal layer have a difference in relative permittivity of 0.3 or less.

(3) In an embodiment of the present invention, the liquid crystal display device includes the structure (2) and the material of the uneven layer and the liquid crystal material of the liquid crystal layer have a difference in relative permittivity of 0.2 or less.

(4) In an embodiment of the present invention, the liquid crystal display device includes the structure (2) or (3) and the material of the uneven layer is a liquid crystal polymer.

The present invention can provide a liquid crystal display device capable of improving the reflectance and the contrast ratio.

### BRIEF DESCRIPTION OF THE DRAWINGS

FIG. 1 is a schematic cross-sectional view of a liquid crystal display device of an embodiment.

FIG. 2 is an enlarged schematic view of the region surrounded by the dotted line in FIG. 1.

FIG. 3 is a schematic cross-sectional view illustrating a mechanism of improving the contrast ratio of the liquid crystal display device of the embodiment.

FIG. 4 is a schematic cross-sectional view illustrating part of a liquid crystal display device of a comparative example of the embodiment.

FIG. 5A is a schematic cross-sectional view illustrating an exemplary production method of the liquid crystal display device of the embodiment.

FIG. 5B is a schematic cross-sectional view illustrating the exemplary production method of the liquid crystal display device of the embodiment.

FIG. 5C is a schematic cross-sectional view illustrating the exemplary production method of the liquid crystal display device of the embodiment.

FIG. 5D is a schematic cross-sectional view illustrating the exemplary production method of the liquid crystal display device of the embodiment.

FIG. 5E is a schematic cross-sectional view illustrating the exemplary production method of the liquid crystal display device of the embodiment.

FIG. 5F is a schematic cross-sectional view illustrating the exemplary production method of the liquid crystal display device of the embodiment.

FIG. 5G is a schematic cross-sectional view illustrating the exemplary production method of the liquid crystal display device of the embodiment.

FIG. 5H is a schematic cross-sectional view illustrating the exemplary production method of the liquid crystal display device of the embodiment.

FIG. 5J is a schematic cross-sectional view illustrating the exemplary production method of the liquid crystal display device of the embodiment.

FIG. 5K is a schematic cross-sectional view illustrating the exemplary production method of the liquid crystal display device of the embodiment.

FIG. 6 is a schematic cross-sectional view illustrating part of a liquid crystal display device of a modified example of the embodiment.

### DETAILED DESCRIPTION OF THE INVENTION

The present invention is described below in more detail based on embodiments with reference to the drawings. The embodiments, however, are not intended to limit the scope of the present invention. The configurations employed in the embodiments may appropriately be combined or modified within the spirit of the present invention.

Herein, “X to Y” means “X or more and Y or less”.

### EMBODIMENT

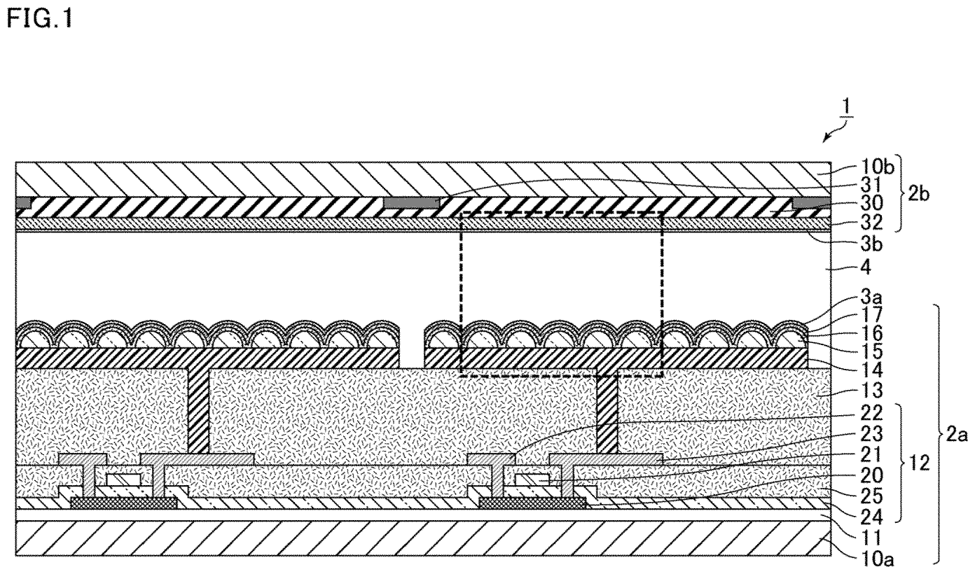

FIG. 1 is a schematic cross-sectional view of a liquid crystal display device of an embodiment. As shown in FIG. 1, a liquid crystal display device 1 includes, in the following order from the back surface side to the viewing surface side, a first substrate 2a, a first alignment film 3a, a liquid crystal layer 4, a second alignment film 3b, and a second substrate 2b. The first substrate 2a and the second substrate 2b face each other. The liquid crystal layer 4 is held between the first substrate 2a and the second substrate 2b.

The “viewing surface side” herein means a side closer to the screen of the liquid crystal display device and in FIG. 1, for example, the upper side (second substrate 2b side) of the liquid crystal display device 1. The “back surface side” herein means a side remote from the screen of the liquid crystal display device and in FIG. 1, for example, the lower side (first substrate 2a side) of the liquid crystal display device 1.

<First Substrate>

The first substrate 2a includes a first support 10a, a base coat layer 11, thin-film transistor elements 12, an insulating resin layer 13, first electrodes 14, an uneven layer 15, an insulating layer 16, and a reflective layer 17. The first substrate 2a is also referred to as a thin-film transistor array substrate.

### (First Support)

Examples of the first support 10a include transparent substrates such as glass substrates and plastic substrates.

### (Base Coat Layer)

The base coat layer 11 is disposed on the liquid crystal layer 4 side surface of the first support 10a.

Examples of the material of the base coat layer 11 include inorganic materials such as silicon nitride (SiN) and silicon dioxide (SiO).

### (Thin-Film Transistor Element)

Each thin-film transistor element 12 includes a semiconductor layer 20, a gate electrode 21, a source electrode 22, a drain electrode 23, a gate insulating film 24, and an interlayer insulating film 25. The semiconductor layer 20 is disposed on the liquid crystal layer 4 side surface of the base coat layer 11 and covered with the gate insulating film 24. The gate electrode 21 is disposed on the liquid crystal layer 4 side surface of the gate insulating film 24 and covered with the interlayer insulating film 25. The source electrode 22 and the drain electrode 23 are disposed on the liquid crystal layer 4 side surface of the interlayer insulating film 25 and covered with the insulating resin layer 13. The source electrode 22 and the drain electrode 23 are each electrically connected to the semiconductor layer 20 through a contact hole (aperture) formed in the gate insulating film 24 and the interlayer insulating film 25. FIG. 1 exemplifies top-gate (staggered type) thin-film transistor elements as the thin-film transistor elements 12. The thin-film transistor elements 12 may be bottom-gate (inverted staggered type) thin-film transistor elements.

Examples of the material of the semiconductor layer 20 include amorphous silicon, polysilicon, an oxide semiconductor, and an organic semiconductor. In order to achieve low power consumption and high-speed driving, an oxide semiconductor is preferred. The oxide semiconductor generates a small amount of off-leakage current (current leakage in the off state of the thin film transistor element 12) to achieve low power consumption and generates a large amount of on-current (current in the on state of the thin film transistor element 12) to achieve high-speed driving. Examples of the oxide semiconductor include a compound containing indium, gallium, zinc, and oxygen and a compound containing indium, tin, zinc, and oxygen.

The materials of the gate electrode 21, the source electrode 22, the drain electrode 23, the gate insulating film 24, and the interlayer insulating film 25 may each be a conventionally known material.

The layers (films) constituting the thin-film transistor elements 12 may each have a single-layer structure or a laminate structure for improving the characteristics.

The driver circuit (e.g., gate driver, source driver) for driving the thin-film transistor elements 12 may be disposed on the first substrate 2a in a region other than the pixel region or may be disposed separately from the first substrate 2a. Each pixel region may include a memory circuit such as a static random access memory (SRAM) circuit.

### (Insulating Resin Layer)

The insulating resin layer 13 is disposed on the liquid crystal layer 4 side surface of each thin-film transistor element 12.

Examples of the material of the insulating resin layer 13 include UV-curable resins such as naphthoquinone azido-based resin and polyalkylsiloxane-based resin.

### (First Electrode)

The first electrodes 14 are disposed on the liquid crystal layer 4 side surface of the insulating resin layer 13 and each have a flat surface on the liquid crystal layer 4 side. The first electrodes 14 are each electrically connected to the corresponding drain electrode 23 through the corresponding contact hole (aperture) formed in the insulating resin layer 13. In other words, each first electrode 14 and the corresponding source electrode 22 are electrically connected through the corresponding semiconductor layer 20 and drain electrode 23. Each thin-film transistor element 12 is turned on or off in response to the gate voltage (scanning signal) applied to the gate electrode 21. When the thin-film transistor element 12 is turned on, the source voltage (video image signal) applied to the source electrode 22 is supplied to the corresponding first electrode 14. Then, the voltage applied between the first electrodes 14 and the later-described second electrode 32 controls the alignment of liquid crystal molecules in the liquid crystal layer 4. That is, the first electrodes 14 are electrodes for applying voltage to the liquid crystal layer 4. The first electrodes 14 are formed for each respective pixel region (each minimum display unit region) and are also referred to as pixel electrodes.

Examples of the material of the first electrodes 14 include transparent conductive materials such as indium tin oxide (ITO) and indium zinc oxide (IZO).

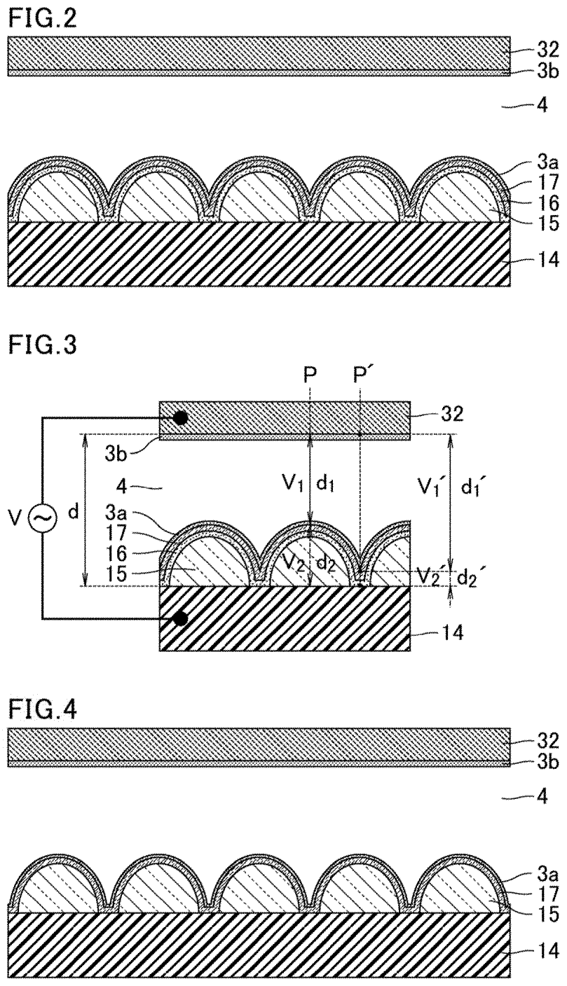

The uneven layer 15, the insulating layer 16, and the reflective layer 17 are specifically described with reference to FIG. 2 as well as FIG. 1. FIG. 2 is an enlarged schematic view of the region surrounded by the dotted line in FIG. 1.

### (Uneven Layer)

The uneven layer 15 is disposed on the liquid crystal layer 4 side surfaces of the first electrodes 14 and is formed from projections. The uneven layer 15 may be directly in contact with the first electrodes 14 as shown in FIG. 2 or may not be directly in contact with the first electrodes 14 (a different layer may be disposed between the uneven layer 15 and the first electrodes 14). The uneven layer 15 functions as a foundation for giving an uneven structure to the reflective layer 17 and resultantly imparts a scattering function to the reflective layer 17.

The material of the uneven layer 15 and the liquid crystal material of the liquid crystal layer 4 have a difference in relative permittivity of 0.3 or less, preferably 0.2 or less, more preferably 0. In other words, the material of the uneven layer 15 and the liquid crystal material of the liquid crystal layer 4 have substantially the same relative permittivity.

The relative permittivity of the material of the uneven layer 15 is preferably 2.0 to 4.0 in terms of reducing the difference in relative permittivity from the liquid crystal material of the liquid crystal layer 4 as much as possible.

The material of the uneven layer 15 is preferably an organic material in terms of processability, more preferably a liquid crystal polymer in terms of reducing the difference in relative permittivity from the liquid crystal material of the liquid crystal layer 4 as much as possible. The material of the uneven layer 15 may have photosensitivity. The relative permittivity of the material of the uneven layer 15 indicates the average of the major-axis relative permittivity of the component molecules (e.g., liquid crystal molecules) and the minor-axis relative permittivity of the component molecules (e.g., liquid crystal molecules).

Any shape may be employed for the projections of the uneven layer 15 as long as the reflective layer 17 can have a scattering function. Examples thereof include hemispheric shapes (ones having a hemispheric cross section as shown in FIG. 2), conical shapes, and pyramid shapes such as trigonal pyramid shapes and quadrilateral pyramid shapes.

The projections of the uneven layer 15 are preferably disposed at intervals in terms of scattering properties.

The projections of the uneven layer 15 are preferably disposed at a constant density in terms of scattering properties.

The projections of the uneven layer 15 preferably have a uniform (substantially the same) height in terms of scattering properties. Specifically, each projection has a height of preferably 0.1 to 10 μm, more preferably 0.5 to 1 μm.

The projections of the uneven layer 15 may each have a single-layer structure or a laminate structure.

### (Insulating Layer)

The insulating layer 16 covers the projections of the uneven layer 15 and includes a first uneven structure on the liquid crystal layer 4 side surface. The first uneven structure of the insulating layer 16 is reflected by the shapes of the projections of the uneven layer 15 as a foundation.

Examples of the material of the insulating layer 16 include inorganic materials such as silicon nitride (SiN) and silicon dioxide (SiO₂) and organic materials such as polyimide. Use of polyimide as the material of the insulating layer 16 increases the heat resistance (reduces dimensional change caused by heat).

The thickness of the insulating layer 16 is preferably 1/10 or smaller of the height of each projection of the uneven layer 15 in terms of reducing the loss of the voltage applied to the liquid crystal layer 4.

The insulating layer 16 may have a single-layer structure or a laminate structure.

### (Reflective Layer)

The reflective layer 17 covers the first uneven structure of the insulating layer 16 and includes a second uneven structure on the liquid crystal layer 4 side surface. The second uneven structure of the reflective layer 17 is reflected by the first uneven structure of the insulating layer 16 as a foundation. In other words, the second uneven structure of the reflective layer 17 is indirectly reflected by the shapes of the projections of the uneven layer 15.

The reflective layer 17, including the second uneven structure on the surface, has a scattering function as well as a reflecting function. The reflective layer 17, including the second uneven structure, can efficiently reflect incident light (external light) from various directions to the front (to the viewing surface side). The reflective layer 17, being closer to the liquid crystal layer 4 than the uneven layer 15 and the insulating layer 16 are, can reduce light loss when the incident light (external light) travels from the liquid crystal layer 4 to the reflective layer 17 and when the light reflected by the reflective layer 17 travels to the liquid crystal layer 4, whereby the reflectance can be increased. The liquid crystal display device 1, including the reflective layer 17, is also referred to as a reflective liquid crystal display device.

The reflective layer 17 is electrically insulated from the first electrodes 14 by the insulating layer 16. The reflective layer 17 is thus electrically floating, whereby the reflective layer 17 and the first electrodes 14 have different potentials. Differently from the first electrodes 14, the reflective layer 17 is not a member for applying voltage to the liquid crystal layer 4.

The material of the reflective layer 17 is preferably a metal material in terms of reflection property, and examples thereof include aluminum, platinum, silver, and an alloy of any of these.

The thickness of the reflective layer 17 is made to be smaller than the height of each projection of the uneven layer 15 so that the reflective layer 17 includes the second uneven structure indirectly reflected by the projections of the uneven layer 15. The thickness is preferably 10 to 1000 nm, more preferably 100 to 200 nm.

The reflective layer 17 may have a single-layer structure or a laminate structure.

### <First Alignment Film>

The first alignment film 3a is disposed on the liquid crystal layer 4 side surface of the first substrate 2a and covers the reflective layer 17. Thus, the first alignment film 3a has an uneven surface on the liquid crystal layer 4 side.

The first alignment film 3a may be an organic alignment film or an inorganic alignment film, and examples thereof include a rubbing alignment film and a photoalignment film. Examples of the rubbing alignment film include alignment films formed from polyimide. Examples of the photoalignment film include alignment films containing a photoreactive functional group such as a cinnamate group, a chalcone group, or an azobenzene group.

The first alignment film 3a may have a single-layer structure or a laminate structure. When the first alignment film 3a has a laminate structure, a layer closer to the liquid crystal layer 4 may mainly control the alignment of the liquid crystal molecules in the liquid crystal layer 4 and a layer farther from the liquid crystal layer 4 may mainly control the electrical characteristics and the mechanical properties.

### <Liquid Crystal Layer>

The liquid crystal material of the liquid crystal layer 4 may be a positive liquid crystal material having positive anisotropy of dielectric constant or a negative liquid crystal material having negative anisotropy of dielectric constant.

<Second Alignment Film 3b>

The second alignment film 3b is disposed on the liquid crystal layer 4 side surface of the second substrate 2b and covers the later-described second electrode 32. The second alignment film 3b has a flat surface on the liquid crystal layer 4 side, similarly to the later-described second electrode 32.

The second alignment film 3b may be an organic alignment film or an inorganic alignment film, and examples thereof include a rubbing alignment film and a photoalignment film. Examples of the rubbing alignment film include alignment films formed from polyimide. Examples of the photoalignment film include alignment films containing a photoreactive functional group such as a cinnamate group, a chalcone group, or an azobenzene group.

The second alignment film 3b may have a single-layer structure or a laminate structure. When the second alignment film 3b has a laminate structure, a layer closer to the liquid crystal layer 4 may mainly control the alignment of the liquid crystal molecules in the liquid crystal layer 4 and a layer farther from the liquid crystal layer 4 may mainly control the electrical characteristics and the mechanical properties.

### <Second Substrate>

The second substrate 2b includes a second support 10b, color filters 30, a black matrix 31, and the second electrode 32. The second substrate 2b is also referred to as a color filter substrate.

### (Second Support)

Examples of the second support 10b include transparent substrates such as glass substrates and plastic substrates.

### (Color Filter)

Each color filter 30 is disposed on the liquid crystal layer 4 side surface of the second support 10b, separately from the black matrix 31. The color filters 30 may provide a single color (e.g., red, green, blue, yellow) for each pixel region.

Examples of the material of the color filters 30 include pigment dispersed color resists.

### (Black Matrix)

The black matrix 31 is disposed on the liquid crystal layer 4 side surface of the second support 10b and defines the pixel regions (color filters 30).

Examples of the material of the black matrix 31 include a black resist.

### (Second Electrode)

The second electrode 32 is disposed on the liquid crystal layer 4 side surface of each color filter 30 in a flat state commonly with all the pixel regions (without divisions). The second electrode 32 is supplied with a voltage common in all the pixel regions. The voltage applied between the first electrodes 14 and the second electrode 32 controls the alignment of the liquid crystal molecules in the liquid crystal layer 4. In other words, the second electrode 32 is an electrode for applying voltage to the liquid crystal layer 4, similarly to the first electrodes 14. The second electrode 32 is also referred to as a common electrode.

Examples of the material of the second electrode 32 include transparent conductive materials such as indium tin oxide (ITO) and indium zinc oxide (IZO).

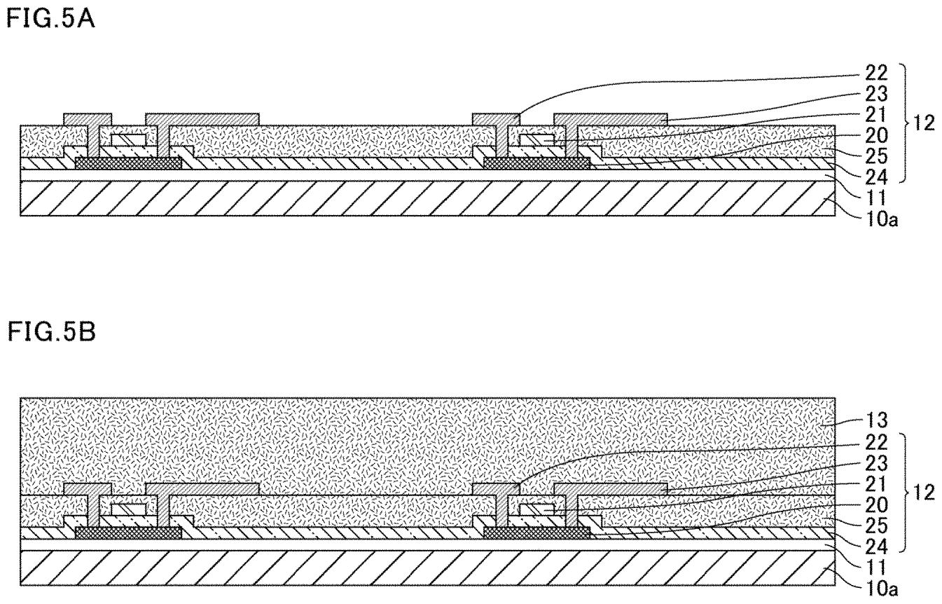

In the liquid crystal display device 1, the liquid crystal layer 4 is held between the reflective layer 17 (first alignment film 3a) having an uneven surface and the second electrode 32 (second alignment film 3b) having a flat surface, and the thickness of the liquid crystal layer 4 thus has positional variation. Meanwhile, the material of the uneven layer 15 and the liquid crystal material of the liquid crystal layer 4 have a difference in relative permittivity of as small as 0.3 or less. Therefore, the contrast ratio can be improved. This mechanism is described with reference to FIG. 3. FIG. 3 is a schematic cross-sectional view illustrating a mechanism of improving the contrast ratio of the liquid crystal display device of the embodiment. FIG. 3 shows the region (part of the region) shown in FIG. 2. Hereinafter, description is made in a manner that the liquid crystal layer 4 includes the first alignment film 3a and the second alignment film 3b because this causes little adverse influence. The uneven layer 15, the insulating layer 16, and the reflective layer 17 are collectively referred to as a scattering reflective layer.

In FIG. 3, d represents the distance between the first electrode 14 and the second electrode 32 and V represents the voltage applied between the first electrode 14 and the second electrode 32. Since the reflective layer 17 and the first electrode 14 are electrically insulated from each other by the insulating layer 16, the voltage applied to the liquid crystal layer 4 is a divided voltage according to the thickness of the liquid crystal layer 4. Since the material of the uneven layer 15 and the liquid crystal material of the liquid crystal layer 4 have a difference in relative permittivity of as small as 0.3 or less (the material of the uneven layer 15 and the liquid crystal material of the liquid crystal layer 4 have substantially the same relative permittivity), the voltage (divided voltage) applied to the liquid crystal layer 4 is proportional to the thickness of the liquid crystal layer 4.

Specifically, when V₁ represents the voltage applied to the liquid crystal layer 4, d₁ represents the thickness of the liquid crystal layer 4, V₂ represents the voltage applied to the scattering reflective layer, and d₂ represents the thickness of the scattering reflective layer, which are all at the position P; and V₁′ represents the voltage applied to the liquid crystal layer 4, d₁′ represents the thickness of the liquid crystal layer 4, V₂′ represents the voltage applied to the scattering reflective layer, and d₂′ represents the thickness of the scattering reflective layer, which are all at the position P′, these parameters satisfy the relations defined by the following formulas (T1), (T2), (T3), and (T4).

V=V₁+V₂=V₁′+V₂′ (T1)

d=d₁+d₂=d₁′+d₂′ (T2)

V₁=d₁×V/d (T3)

V₁′=d₃′×V/d (T4)

The retardation of the liquid crystal layer 4 is known to be expressed by the product of the refractive index anisotropy of the liquid crystal material and the thickness of the liquid crystal layer. Studies by the present inventor revealed that the refractive index anisotropy of the liquid crystal material is inversely proportional to the voltage applied to the liquid crystal layer. Accordingly, when δ₁ represents the retardation of the liquid crystal layer 4 and Δn₁ represents the refractive index anisotropy of the liquid crystal material, which are both at the position P; δ₁′ represents the retardation of the liquid crystal layer 4 and Δn₁′ represents the refractive index anisotropy of the liquid crystal material, which are both at the position P′; and k represents a proportionality constant, these parameters satisfy the relations defined by the following formulas (T5) and (T6) that are based on the above formulas (T3) and (T4).

δ₁=Δn₁×d₁=(k/V₁)×d₁=k×d/V (T5)

δ₁′=Δn₁′×d₁′=(k/V₁′)×d₁′=k×d/V (T6)

These results in the relation: δ₁=δ₁′, which means that the retardation of the liquid crystal layer 4 is constant at any position. As a result, the contrast ratio of the liquid crystal display device 1 can be improved.

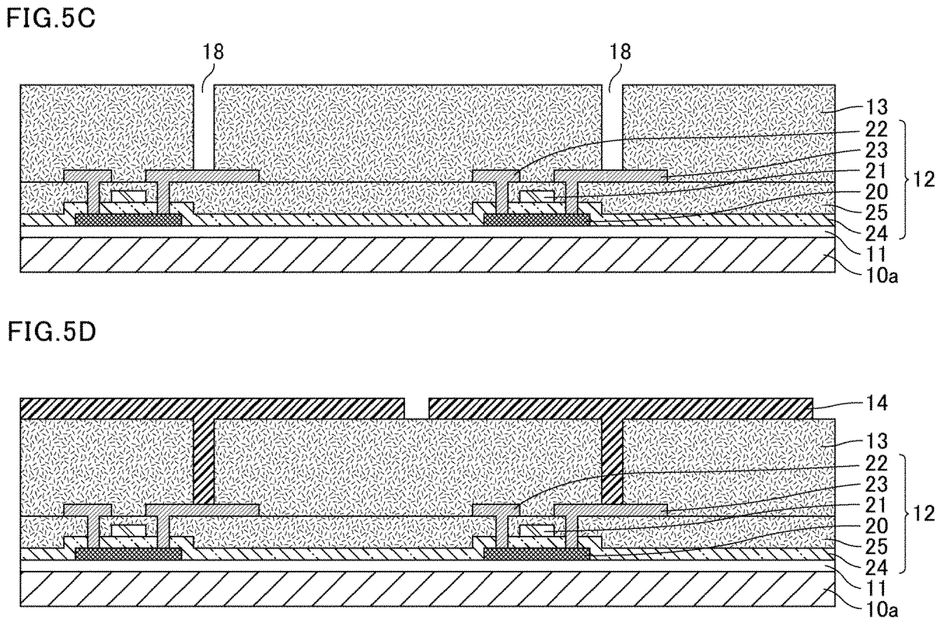

FIG. 4 is a schematic cross-sectional view illustrating part of a liquid crystal display device of a comparative example of the embodiment. As shown in FIG. 4, in the case where no insulating layer 16 is disposed and the reflective layer 17 and each first electrode 14 are thus electrically connected, the reflective layer 17 and the first electrode 14 have the same potential. Thus, when voltage is applied between the first electrode 14 and the second electrode 32, the voltage applied to the liquid crystal layer 4 is constant at any position. As a result, the refractive index anisotropy of the liquid crystal material is constant at any position, which causes the retardation of the liquid crystal layer 4 to have positional variation proportional to the thickness (leading to a locally reduced contrast ratio).

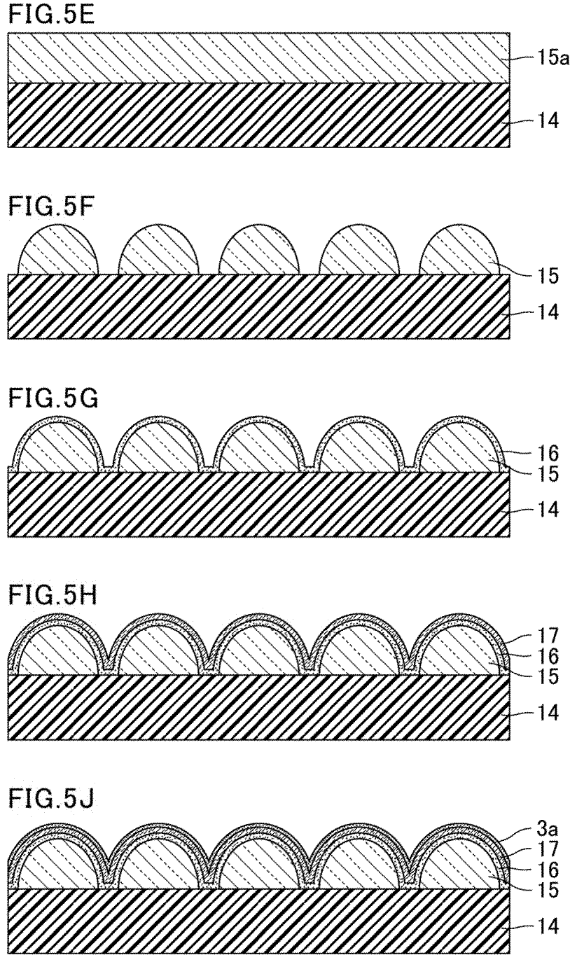

The liquid crystal display device of the embodiment can be produced by the following method, for example. FIG. 5A, FIG. 5B, FIG. 5C, FIG. 5D, FIG. 5E, FIG. 5F, FIG. 5G, FIG. 5H, FIG. 5J, and FIG. 5K are schematic cross-sectional views illustrating an exemplary production method of a liquid crystal display device of the embodiment. In FIG. 5E, FIG. 5F, FIG. 5G, FIG. 5H, FIG. 5J, and FIG. 5K, layers below the first electrodes 14 are not shown.

### (A) Formation of Base Coat Layer and Thin-Film Transistor Element

As shown in FIG. 5A, on a surface of the first support 10a are formed the base coat layer 11 and the thin-film transistor elements 12 (each including the semiconductor layer 20, the gate electrode 21, the source electrode 22, the drain electrode 23, the gate insulating film 24, and the interlayer insulating film 25) in the stated order by a conventionally known method.

### (B) Formation of Insulating Resin Layer

As shown in FIG. 5B, the insulating resin layer 13 is formed on the surface remote from the first support 10a of each thin-film transistor element 12 by a conventionally known method.

### (C) Formation of Contact Hole

As shown in FIG. 5C, contact holes 18 are formed in the insulating resin layer 13 by photolithography, for example, with each drain electrode 23 partly exposed.

### (D) Formation of First Electrode.

As shown in FIG. 5D, each first electrode 14 is formed on the surface remote from the first support 10a of the insulating resin layer 13 by sputtering or vapor deposition, for example, so as to be electrically connected to the drain electrodes 23 through the corresponding contact hole 18. Here, the first electrodes 14 are formed for each pixel region by a combination of wet etching and dry etching, for example.

### (E) Film Formation Using Material of Uneven Layer

As shown in FIG. 5E, a film 15a is formed from a material of an uneven layer on the surface remote from the first support 10a of each first electrode 14 by spin coating, slit coating, sputtering, or vapor deposition, for example. The film 15a of the material of an uneven layer is formed to have an easily controllable thickness of preferably 0.1 to 10 μm, more preferably 0.5 to 1 μm.

### (F) Formation of Uneven Layer

As shown in FIG. 5F, the film 15a of the material of an uneven layer is subjected to shape processing such that the resulting uneven layer 15 has projections with intervals. The shape processing may be performed by wet etching, dry etching, or photolithography (in the case where the material of the uneven layer 15 has photosensitivity), for example. Differently from the state as shown in FIG. 5F, if shape processing is performed such that projections are continuously formed without intervals by etching such as wet etching or dry etching, for example, the etching of the film 15a of the material of an uneven layer needs to be stopped before the etched portions expose the first electrode 14. Unfortunately, when the depth of etching is controlled as described, the depth of etching significantly varies, possibly resulting in variation in scattering properties between pixel regions. In contrast, when the film 15a of the material of an uneven layer is etched such that projections are formed with intervals, the etching can be easily controlled, resulting in reduced variation in scattering properties.

### (G) Formation of Insulating Layer

As shown in FIG. 5G, the insulating layer 16 is formed so as to cover the projections of the uneven layer 15. Thereby, the insulating layer 16 includes on the surface remote from the uneven layer 15 first uneven structures reflected by the shapes of the projections of the uneven layer 15. The insulating layer 16 may be a film obtained by forming a film of an inorganic material such as silicon nitride (SiN) or silicon dioxide (SiO) by a method such as sputtering or vapor deposition or by forming a film of an organic material such as polyimide by spin coating. The thickness of the insulating layer 16 is preferably 1/10 or smaller of the height of each projection of the uneven layer 15, which can reduce the loss of the voltage applied to the liquid crystal layer 4 that is produced later.

### (H) Formation of Reflective Layer

As shown in FIG. 5H, the reflective layer 17 is formed so as to cover the first uneven structure of the insulating layer 16. Thereby, the reflective layer 17 includes on the surface remote from the insulating layer 16 a second uneven structure reflected by the first uneven structure of the insulating layer 16. The reflective layer 17 is formed such that it is electrically insulated from the first electrode 14 by the insulating layer 16. The reflective layer 17 may be a film obtained by forming a film of a metal material such as aluminum, platinum, silver, or an alloy of any of these by sputtering or vapor deposition. The thickness of the reflective layer 17 is smaller than the heights of the projections of the uneven layer 15, preferably 10 to 1000 nm, more preferably 100 to 200 nm so that the reflective layer 17 can include the second uneven structure indirectly reflected by the shapes of the projections of the uneven layer 15.

The processes (A) to (H) provide the first substrate 2a (FIG. 1 shows the entire figure).

### (J) Formation of First Alignment Film

As shown in FIG. 5J, the first alignment film 3a is formed on the surface remote from the insulating layer 16 of the reflective layer 17. Thereby, the first alignment film 3a has an uneven surface on the side remote from the reflective layer 17. In formation of the first alignment film 3a, drying, baking, alignment treatment (e.g., rubbing treatment, photoalignment treatment), or the like may be performed.

### (K) Completion of Liquid Crystal Display Device

On the surface of the second support 10b are formed the color filters 30, the black matrix 31, and the second electrode 32 by conventionally known methods, whereby the second substrate 2b (FIG. 1 shows the entire figure) is formed. Then, the second alignment film 3b is formed on the surface remote from the second support 10b of the second electrode 32. Here, drying, baking, alignment treatment (e.g., rubbing treatment, photoalignment treatment), or the like may be performed. Then, as shown in FIG. 5K, the first substrate 2a (partly shown) and the second substrate 2b (partly shown) are attached such that the liquid crystal layer 4 is formed between the first alignment film 3a and the second alignment film 3b. Thereby, the liquid crystal display device 1 as shown in FIG. 1 is completed.

In the embodiment, a laminate of the uneven layer 15 and the insulating layer 16 is disposed as a foundation of the reflective layer 17. As a modified example thereof, the uneven layer 15 and the insulating layer 16 may be integrated.

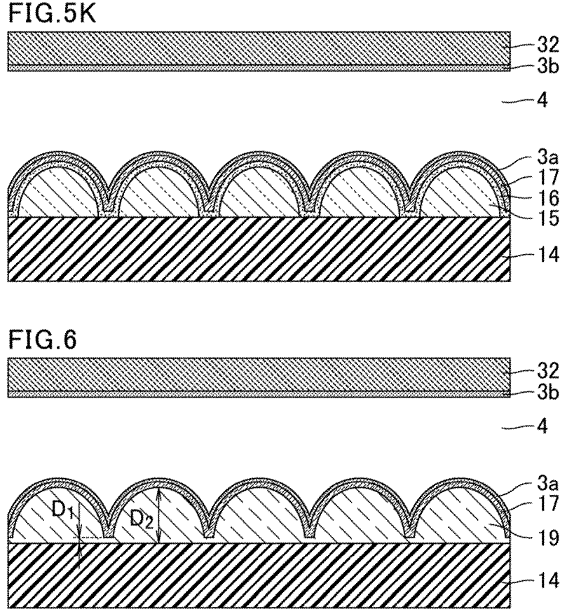

FIG. 6 is a schematic cross-sectional view illustrating part of a liquid crystal display device of a modified example of the embodiment. As shown in FIG. 6, each first electrode 14 has on the liquid crystal layer 4 side surface an uneven insulating layer 19 in which the uneven layer 15 and the insulating layer 16 in the embodiment are integrated. The uneven insulating layer 19 includes the first uneven structure on the liquid crystal layer 4 side surface. The uneven insulating layer 19 may be directly in contact with the first electrode 14 as shown in FIG. 6 or may not be in directly contact with the first electrode 14 (a different layer may be disposed between the uneven insulating layer 19 and the first electrode 14).

The material of the uneven insulating layer 19 and the liquid crystal material of the liquid crystal layer 4 have a difference in relative permittivity of 0.3 or less, preferably 0.2 or less, more preferably 0. The material of the uneven insulating layer 19 is preferably a liquid crystal polymer in terms of reducing the difference in relative permittivity from the liquid crystal material of the liquid crystal layer 4 as much as possible.

The reflective layer 17 covers the first uneven structure of the uneven insulating layer 19 and includes the second uneven structure on the liquid crystal layer 4 side surface. The reflective layer 17 is electrically insulated from the first electrode 14 by the uneven insulating layer 19. In order to achieve the electric insulation between the reflective layer 17 and the first electrode 14, in formation of the uneven insulating layer 19 (first uneven structure), a uniform-thickness film of the material of the uneven insulating layer 19 is etched and the etching is stopped before the etched portions expose the first electrode 14, for example. When the uneven insulating layer 19 is formed in such a manner, the minimum thickness D₁ (thickness of the portion most deeply etched) is preferably 1/10 or smaller of the maximum thickness D₂ (thickness of the portion most shallowly etched: height of the projection).

### EXAMPLES AND COMPARATIVE EXAMPLES

The present invention is described below in more detail based on examples and comparative examples. The examples, however, are not intended to limit the scope of the present invention.

### Example 1

A liquid crystal display device of Example 1 is the liquid crystal display device of the embodiment (FIGS. 1 and 2). The material of the uneven layer 15 was a liquid crystal polymer A having an average relative permittivity of 2.8. The liquid crystal material of the liquid crystal layer 4 was a liquid crystal material L having an average relative permittivity of 2.8.

### Example 2

A liquid crystal display device of Example 2 was produced in the same manner as in Example 1 except for using a liquid crystal polymer B having an average relative permittivity of 3.0 as the material of the uneven layer 15.

### Example 3

A liquid crystal display device of Example 3 was produced in the same manner as in Example 1 except for using a liquid crystal polymer C having an average relative permittivity of 2.6 as the material of the uneven layer 15.

### Example 4

A liquid crystal display device of Example 4 was produced in the same manner as in Example 1 except for using a liquid crystal polymer D having an average relative permittivity of 3.1 as the material of the uneven layer 15.

### Example 5

A liquid crystal display device of Example 5 was produced in the same manner as in Example 1 except for using a liquid crystal polymer E having an average relative permittivity of 2.5 as the material of the uneven layer 15.

### Comparative Example 1

A liquid crystal display device of Comparative Example 1 was produced in the same manner as in Example 1 except for using a liquid crystal polymer F having an average relative permittivity of 3.2 as the material of the uneven layer 15.

### Comparative Example 2

A liquid crystal display device of Comparative Example 2 was produced in the same manner as in Example 1 except for using polyimide having an average relative permittivity of 3.5 as the material of the uneven layer 15.

### Comparative Example 3

A liquid crystal display device of Comparative Example 3 is the liquid crystal display device (FIG. 4) of the comparative example of the embodiment. The material of the uneven layer 15 was the liquid crystal polymer A having an average relative permittivity of 2.8 used in Example 1. The liquid crystal material of the liquid crystal layer 4 was the liquid crystal material L having an average relative permittivity of 2.8 used in Example 1.

### [Evaluation]

The liquid crystal display devices of Examples 1 to 5 and Comparative Examples 1 to 3 were each evaluated for the reflectance and contrast ratio. Specifically, the reflectance in the white display state and the reflectance in the black display state were measured with a spectral colorimeter “CM-700d” available from Konica Minolta, Inc. The reflectance in the white display state was defined as the “reflectance” in the present evaluation and the ratio of the reflectance in the white display state to the reflectance in the black display state was defined as the “contrast ratio” of the present evaluation. Table 1 shows the evaluation results.

TABLE 1

| | Uneven layer | | Liquid crystal layer | | Optical characteristics | |
|---|---|---|---|---|---|---|
| | | Average relative | | Average relative | Reflectance | Contrast |
| | Material | permittivity | Material | permittivity | (%) | ratio |
| Example 1 | Liquid crystal | 2.8 | Liquid crystal | 2.8 | 75 | 30 |
| | polymer A | | material L | | | |
| Example 2 | Liquid crystal | 3.0 | Liquid crystal | 2.8 | 75 | 30 |
| | polymer B | | material L | | | |
| Example 3 | Liquid crystal | 2.6 | Liquid crystal | 2.8 | 75 | 30 |
| | polymer C | | material L | | | |
| Example 4 | Liquid crystal | 3.1 | Liquid crystal | 2.8 | 75 | 29 |
| | polymer D | | material L | | | |
| Example 5 | Liquid crystal | 2.5 | Liquid crystal | 2.8 | 75 | 29 |
| | polymer E | | material L | | | |
| Comparative | Liquid crystal | 3.2 | Liquid crystal | 2.8 | 75 | 25 |
| Example 1 | polymer F | | material L | | | |
| Comparative | Polyimide | 3.5 | Liquid crystal | 2.8 | 75 | 21 |
| Example 2 | | | material L | | | |
| Comparative | Liquid crystal | 2.8 | Liquid crystal | 2.8 | 75 | 15 |
| Example 3 | polymer A | | material L | | | |

Table 1 shows that the liquid crystal displays of Examples 1 to 5 each had a higher contrast ratio than those of Comparative Examples 1 to 3 although the reflectance values were the same between the examples and the comparative examples. The liquid crystal displays of Examples 2 and 3 each had the same contrast ratio and the same tinge in the black display state as those of Example 1. The liquid crystal displays of Examples 4 and 5 each had the same tinge in the black display state as that of Example 1 although having a lower contrast ratio. The liquid crystal displays of Comparative Examples 1 to 3 had a whitish tinge in the black display state as compared with those of Examples 1 to 5. In particular, the liquid crystal displays of Comparative Examples 2 and 3 had a significantly whitish tinge in the black display state.

What is claimed is:

1. A liquid crystal display device comprising:
a first substrate;
a second substrate facing the first substrate; and
a liquid crystal layer between the first substrate and the second substrate,
the first substrate including first electrodes for applying voltage to the liquid crystal layer, an uneven insulating layer disposed on a liquid crystal layer side of the first electrodes and including a first uneven structure on a liquid crystal layer side surface, and a reflective layer covering the first uneven structure of the uneven insulating layer and including a second uneven structure on a liquid crystal layer side surface,
the reflective layer being electrically insulated from the first electrodes by the uneven insulating layer,
a material of the uneven insulating layer and a liquid crystal material of the liquid crystal layer having a difference in relative permittivity of 0.3 or less,
the second substrate including a second electrode for applying voltage to the liquid crystal layer.

2. The liquid crystal display device according to claim 1,
wherein the uneven insulating layer is disposed on the liquid crystal layer side of the first electrodes and includes an uneven layer formed of projections and an insulating layer covering the projections of the uneven layer and including the first uneven structure on the liquid crystal layer side surface,
the reflective layer is electrically insulated from the first electrodes by the insulating layer, and
a material of the uneven layer and the liquid crystal material of the liquid crystal layer have a difference in relative permittivity of 0.3 or less.

3. The liquid crystal display device according to claim 2,
wherein the material of the uneven layer and the liquid crystal material of the liquid crystal layer have a difference in relative permittivity of 0.2 or less.

4. The liquid crystal display device according to claim 2,
wherein the material of the uneven layer is a liquid crystal polymer.
